(19) United States
(12) Patent Application Publication
(10) Pub. No.: US 2007/0028092 A1
(43) Pub. Date: Feb. 1, 2007

(54) Method and system for enabling chap authentication over PANA without using EAP

(76) Inventor: Alper Yegin, Istanbul (TR)

Correspondence Address: KNOBBE MARTENS OLSON & BEAR LLP, 2040 MAIN STREET, FOURTEENTH FLOOR, IRVINE, CA, 92614, US

(21) Appl. No.: 11/433,667

(22) Filed: May 12, 2006

Related U.S. Application Data
(60) Provisional application No. 60/703,769, filed on Jul. 28, 2005.

(51) Int. Cl. H04L 9/00

(52) U.S. Cl. 713/155

(57) ABSTRACT

A method of authenticating a communication entity in a communication system based on a protocol for carrying authentication for network access (PANA) is disclosed. In one embodiment, the method includes i) transmitting, at a PANA authentication agent (PAA), a PANA start request (PSR) message to a PANA client (PaC), wherein the PSR message includes a field which allows the PaC to select one of a plurality of authentication protocols, ii) receiving, at the PaC, the PSR message, iii) selecting, at the PaC, one of the plurality of protocols and iv) transmitting, at the PaC, a PANA start answer (PSA) message to the PAA, wherein the PSA message includes a field indicative of the selected protocol.

### RELATED APPLICATIONS

This application claims priority under 35 U.S.C. § 119(e) from provisional application No. 60/703,769 filed Jul. 28, 2005, which is hereby incorporated by reference.

### BACKGROUND OF THE INVENTION

1. Field of the Invention

This invention relates to a data communication system, and particularly to a method and system for authenticating a communication entity based on a protocol for carrying authentication for network access (PANA).

2. Description of the Related Technology

Recently a variety of computer network systems have been widely used. In a computer network system a plurality of entities communicate data with each other. In order to protect system resources and an authorized entity, it is typical that an authentication, which is the act of verifying an identity of an entity, is performed before initiating data communication. Several authentication protocols for wired or wireless communication networks have been developed and used.

Among the authentication protocols, an extensible authentication protocol (EAP) and a protocol for carrying authentication for network access (PANA) are frequently used for authentication in Internet protocol (IP) network systems.

### SUMMARY OF CERTAIN INVENTIVE ASPECTS OF THE INVENTION

One aspect of the invention provides a method of authenticating a communication entity in a communication system based on a protocol for carrying authentication for network access (PANA). In one embodiment, the method comprises i) transmitting, at a PANA authentication agent (PAA), a PANA start request (PSR) message to a PANA client (PaC), wherein the PSR message includes a field which allows the PaC to select one of a plurality of authentication protocols, ii) receiving, at the PaC, the PSR message, iii) selecting, at the PaC, one of the plurality of protocols and iv) transmitting, at the PaC, a PANA start answer (PSA) message to the PAA, wherein the PSA message includes a field indicative of the selected protocol.

Another aspect of the invention provides a method of authenticating a communication entity in a communication system based on a protocol for carrying authentication for network access (PANA). In one embodiment, the method comprises i) transmitting a PANA start request (PSR) message to a PANA client (PaC), wherein the PSR message includes a code which allows the PaC to select one of a plurality of authentication protocols and ii) receiving a PANA start answer (PSA) message from the PaC, wherein the PSA message includes a code indicative of a selected one of the plurality of authentication protocols.

Another aspect of the invention provides a system for authenticating a communication entity in a communication system based on a protocol for carrying authentication for network access (PANA). In one embodiment, the system comprises i) a transmitter configured to transmit a PANA start request (PSR) message to a PANA client (PaC), wherein the PSR message includes a code which allows the PaC to select one of a plurality of authentication protocols and ii) a receiver configured to receive a PANA start answer (PSA) message from the PaC, wherein the PSA message includes a code indicative of a selected one of the plurality of authentication protocols.

Another aspect of the invention provides a system for authenticating a communication entity in a communication system based on a protocol for carrying authentication for network access (PANA). In one embodiment, the system comprises i) means for receiving a PANA start request (PSR) message from a PANA authentication agent (PAA), wherein the PSR message includes an authentication type field listing a plurality of authentication protocols, ii) means for selecting a protocol from the plurality of protocols and iii) means for transmitting a PANA start answer (PSA) message to the PAA, wherein the PSA message includes an authentication type field indicative of the selected protocol.

Still another aspect of the invention provides a method of authenticating a communication entity in a communication system based on a protocol for carrying authentication for network access (PANA). In one embodiment, the method comprises i) transmitting a PANA start request (PSR) message to a PANA client (PaC), wherein the PSR message includes a field which allows the PaC to select one of an extensible authentication protocol (EAP) and a challenge handshake authentication protocol (CHAP) and ii) receiving a PANA start answer (PSA) message from the PaC, wherein the PSA message includes a field indicative of a selected one of EAP and CHAP.

Still another aspect of the invention provides a computer data signal for authenticating a communication entity in a communication system based on a protocol for carrying authentication for network access (PANA). In one embodiment, the signal comprises a PANA start request (PSR) message which is configured to be transmitted to a PANA client (PaC), wherein the PSR message includes a code which allows the PaC to select one of an extensible authentication protocol (EAP) and a challenge handshake authentication protocol (CHAP).

Still another aspect of the invention provides a method of authenticating a communication entity in a communication system based on a protocol for carrying authentication for network access (PANA). In one embodiment, the method comprises i) transmitting, at a PANA authentication agent (PAA), a PANA start request (PSR) message to a PANA client (PaC), wherein the PSR message includes a field which allows for the use of a challenge handshake authentication protocol (CHAP) without an extensible authentication protocol (EAP), ii) receiving, at the PaC, the PSR message, iii) transmitting, at the PaC, a PANA start answer (PSA) message to the PAA, wherein the PSA message includes a field which confirms the use of CHAP without EAP and iv) proceeding authentication with CHAP without using EAP.

Yet another aspect of the invention provides a method of authenticating a communication entity in a communication system based on a protocol for carrying authentication for network access (PANA). In one embodiment, the method comprises i) transmitting a PANA start request (PSR) message to a PANA client (PaC), wherein the PSR message includes a field which allows for the use of a challenge handshake authentication protocol (CHAP) without an extensible authentication protocol (EAP) and ii) receiving a PANA start answer (PSA) message from the PaC, wherein the PSA message includes a field which confirms the use of CHAP without EAP.

### BRIEF DESCRIPTION OF THE DRAWINGS

The foregoing and other features of the invention will become more fully apparent from the following description and appended claims taken in conjunction with the following drawings, in which like reference numerals indicate identical or functionally similar elements.

FIG. 1 illustrates a typical PANA based authentication system.

FIG. 2 illustrates a protocol structure of a typical PANA based authentication system.

FIG. 3 illustrates a protocol structure of a PANA based authentication system according to one embodiment of the invention.

FIG. 4 illustrates an exemplary flowchart which shows a PANA based authentication procedure according to one embodiment of the invention.

FIG. 5 illustrates an exemplary call flow diagram which shows a PANA based authentication procedure according to one embodiment of the invention.

FIG. 6 illustrates an exemplary data format of an attribute value pair (AVP) field according to one embodiment of the invention.

FIG. 7 illustrates an exemplary data format of an attribute value pair (AVP) field according to another embodiment of the invention.

FIG. 8 illustrates an exemplary flowchart which shows a PANA based authentication procedure according to another embodiment of the invention.

### DETAILED DESCRIPTION OF CERTAIN EMBODIMENTS OF THE INVENTION

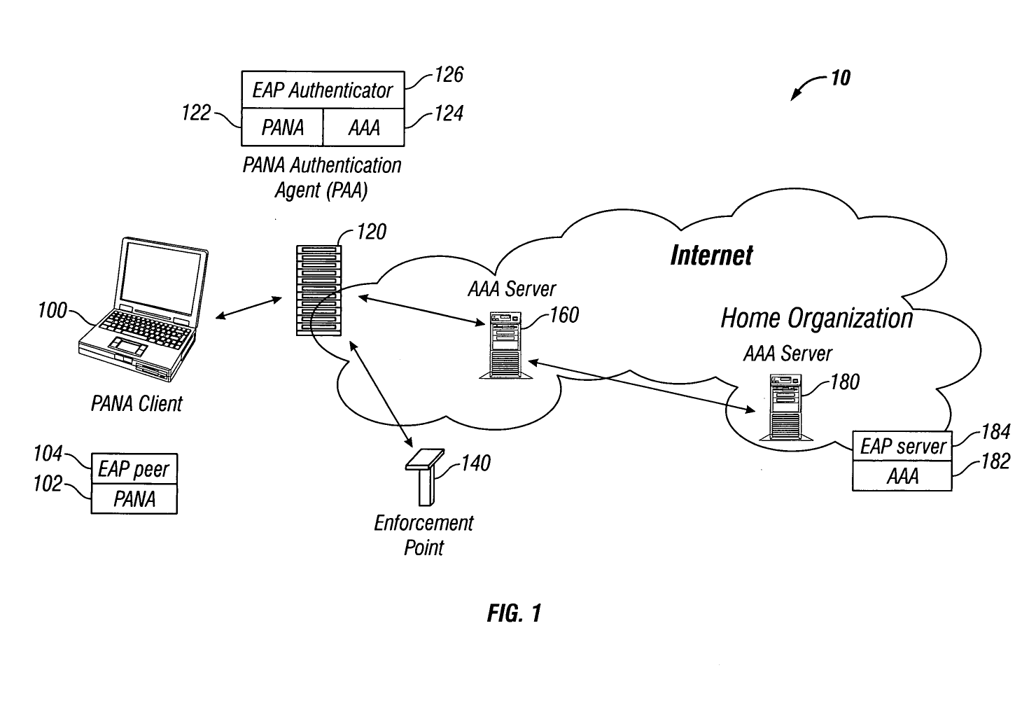

FIG. 1 illustrates a typical PANA based authentication system. The system 10 includes a PANA client (PaC) 100, a PANA authentication agent (PAA) 120 and authentication, authorization and accounting (AAA) servers 160 and 180. In one embodiment, data communication within the system 10 is carried out using wireless or wired communication standards which are compatible with PANA and either known today or developed in the future.

PANA (see 102 and 122) is a transport protocol for carrying authentication for network access. The PANA protocol is run between the PaC 100 and the PAA 120 in order to perform authentication and authorization for network access service. PANA generally carries EAP (see 104, 126 and 184) which can carry various authentication methods. EAP is an authentication framework which supports multiple authentication methods. EAP is used to select a specific authentication mechanism such as PANA or a challenge handshake authentication protocol (CHAP). By transporting EAP over IP, any authentication method that can be carried as an EAP method is made available to PANA. PAPA covers the client-to-network access authentication part of an overall secure network access framework, which additionally includes other protocols and mechanisms for service providing, access controls as a result of initial authentication, and accounting.

The PaC 100 is the client side of the protocol that resides in an access device. In one embodiment, the PaC 100 (or the access device) may be, for example, a personal computer (desktop, laptop and palmtop), a mobile phone, or other portable communication devices such as a hand-held PC, a wallet PC and a personal digital assistant (PDA). The PaC 100 is responsible for providing the credentials in order to prove its identity (authentication) for network access authorization. The EAP peer 104 generally resides in the PaC device 100 as shown in FIG. 1. The PAA 120 is the server side of the protocol and responsible for verifying the credentials provided by the PaC 100 and authorizes network access to the PaC device 100. The EAP authenticator 126 generally resides in the PAA server 120 as shown in FIG. 1. The PAA 120 communicates data with the AAA servers 160 and 180 via AAA protocol (see 124 and 182). An enforcement point 140 is in charge of preventing unauthorized use of the network.

The PANA protocol messaging includes a series of request and responses, some of which may be initiated by either end of the communication channel. Each message can carry zero or more attribute value pairs (AVPs) as payload. The main payload of PANA is an EAP which performs authentication. PANA helps the PaC 100 and PAA 120 establish an EAP session.

A description of the general operation of a typical PANA system including PAA and PaC can be found, for example, by Forsberg, D., Ohba, Y., Patil, B., Tschofenig, H. and A. Yegin, at “Protocol for Carrying Authentication for Network Access,” draft-ietf-pana-pana-10, July 2005, which is incorporated herein by reference. Furthermore, the specification of the EAP protocol can be found, for example, by Aboba, B., Blunk, L., Vollbrecht, J., Carlson, J., Levkowetz, H. at “Extensible Authentication Protocol (EAP),” RFC 3748, June 2004, which is incorporated herein by reference.

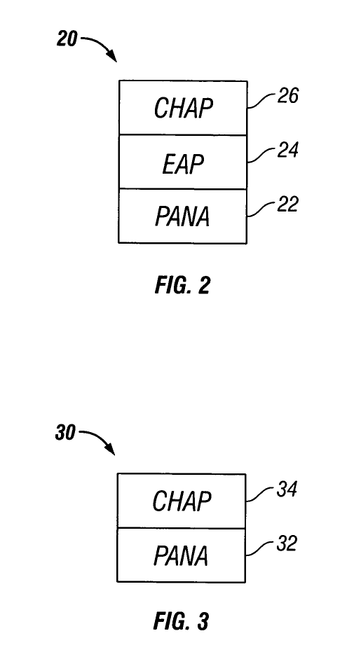

FIG. 2 illustrates a protocol structure of a typical PANA based authentication system. The protocol structure 20 includes PANA 22, EAP 24 and CHAP 26. PANA 22 allows for the use of any authentication mechanism as long as it can be implemented as an EAP method. CHAP-based authentication method is ubiquitously used in various platforms such as code division multiple access (CDMA) 2000 Simple IP service, CDMA 2000 mobile IP service and digital subscriber line (DSL) broadband access. Legacy protocols can carry authentication natively, for example, point-to-point protocol (PPP) CHAP or mobile IPv4 challenge-response authentication. However, the current design of PANA requires use of EAP 24 for any authentication method. Thus, CHAP 26 cannot be carried unless EAP 24 is carried by PANA 22 as shown in FIG. 2. In networks where CHAP 26 is the only or dominantly used authentication method, cost of inserting EAP 24 in the stack exceeds the benefits gained from it.

One aspect of the invention provides a PANA based authentication system which allows for a PaC to select one of a plurality of authentication protocols provided by a PAA. Another aspect of the invention provides a PANA based authentication system which allows for the use of CHAP/PANA instead of CHAP/EAP/PANA stack. Still another aspect of the invention provides a PANA based authentication system which allows for the PAA to initiate CHAP during an authentication type negotiation phase.

FIG. 3 illustrates a protocol structure of a PANA based authentication system according to one embodiment of the invention. The protocol structure 30 includes PANA 32 and CHAP 34. The protocol structure 30 allows for the use of CHAP/PANA instead of CHAP/EAP/PANA stack. That is, as shown in FIG. 3, the CHAP protocol 34 is located directly over PANA 32.

A description of the CHAP protocol and authentication method using CHAP can be found, for example, by 1) Rivest, R., and S. Dusse, at “the MD5 Message-Digest Algorithm,” RFC 1321, April 1992, 2) Simpson, W., at “PPP Challenge Handshake Authentication Protocol (CHAP),” RFC 1994, August 1996 and 3) Perkins, C. and Calhoun, P., at “Mobile IPv4 Challenge/Response Extensions,” RFC 3012, November 2000, each of which is incorporated herein by reference.

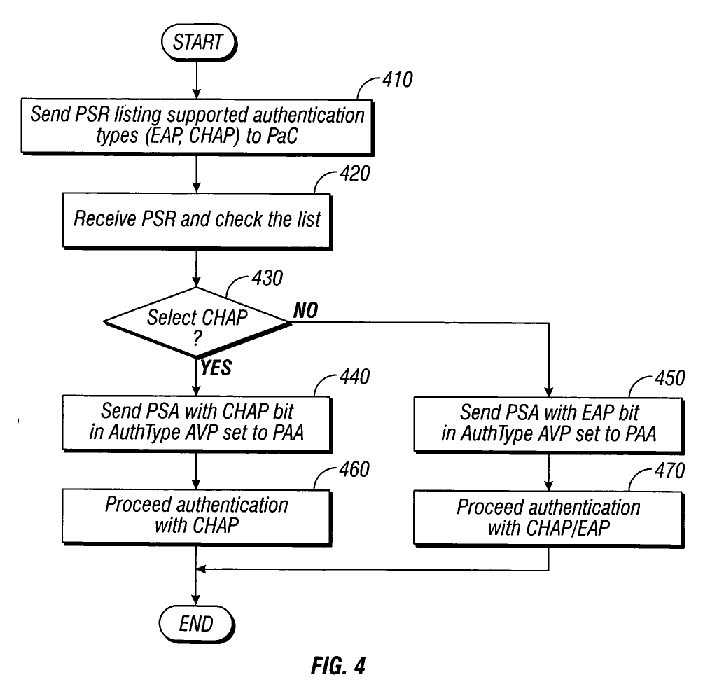

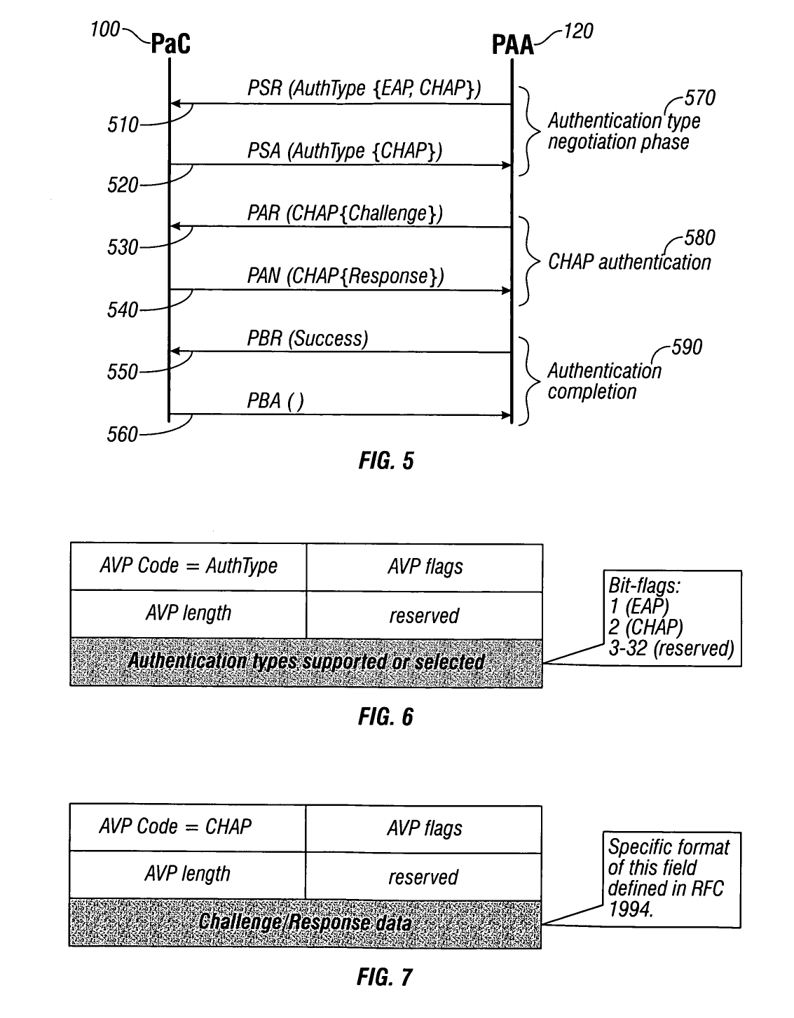

FIG. 4 illustrates an exemplary flowchart which shows a PANA based authentication procedure according to one embodiment of the invention. In one embodiment, the authentication procedure is implemented in a conventional programming language, such as C or C++ or another suitable programming language. In one embodiment of the invention, the program is stored on a computer accessible storage medium at the PaC 100 or PAA 120 (see FIGS. 1 and 5). In another embodiment, the program can be stored in other system locations so long as it can perform the authentication procedure according to embodiments of the invention. The storage medium may comprise any of a variety of technologies for storing information. In one embodiment, the storage medium comprises a random access memory (RAM), hard disks, floppy disks, digital video devices, compact discs, video discs, and/or other optical storage mediums, etc.

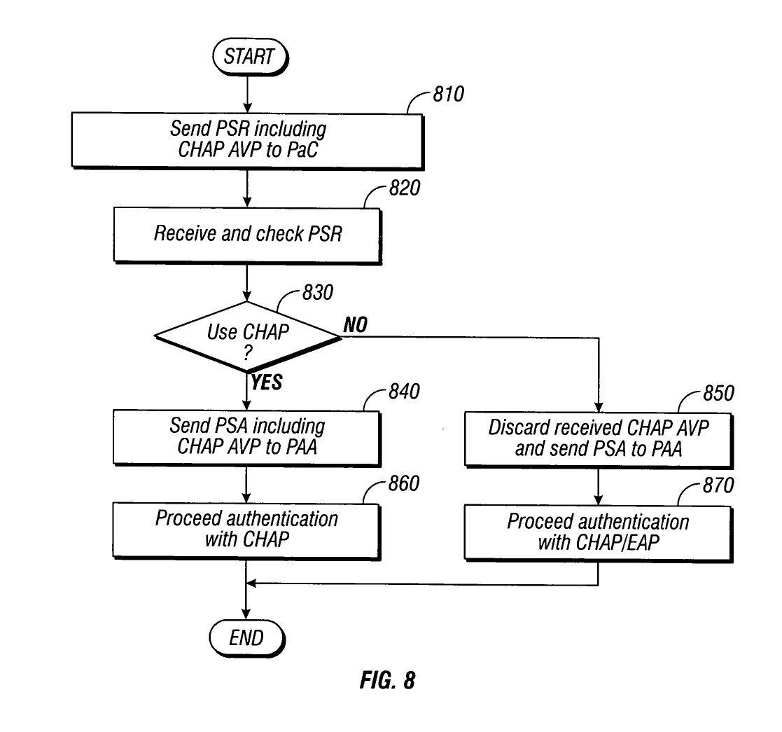

In one embodiment, the authentication procedure may be implemented with a variety of network systems including the FIG. 1 system, code division multiple access (CDMA) 2000 Simple IP service system, CDMA 2000 mobile IP service system and digital subscriber line (DSL) broadband access system. In one embodiment, the PAA 120 may perform the authentication processing while communicating data with the AAA servers 160 and 180. In another embodiment, the PAA 120 may independently perform the authentication processing. This description can be applied to the authentication procedure illustrated in FIG. 8.

In one embodiment, each of the PaC 100 and PAA 120 comprises a processor (not shown) configured to or programmed to perform the authentication method according to embodiments of the invention such as a procedure illustrated in FIGS. 5 and 8. The program may be stored in the processor or a memory of the PaC 100 and/or PAA 120. In various embodiments, the processor may have a configuration based on Intel Corporation's family of microprocessors, such as the Pentium family and Microsoft Corporation's windows operating systems such as WINDOWS 95, WINDOWS 98, WINDOWS 2000 or WINDOWS NT. In one embodiment, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 2000/9x/ME/XP, Macintosh OS, OS/2 and the like.

Referring to FIGS. 5-6, the authentication procedure as shown in FIG. 4 will be described in more detail. The PAA 120 sends a PANA start request (PSR) message listing supported authentication types (or protocols) to the PaC 100 (410 in FIG. 4 and 510 in FIG. 5). In one embodiment, the PSR message includes a field which allows the PaC 100 to select one of a plurality of authentication protocols. In one embodiment, the authentication protocols include EAP and CHAP as shown in FIGS. 4-6. In another embodiment, the authentication protocols may include another authentication protocols as long as they are compatible with PANA. For example, certain authentication protocols prove to be as popular as CHAP in the future, native support for them can be added to PANA along with the lines of CHAP/PANA.

In one embodiment, the field (or code) of the PSR message is an authentication type (AuthType) AVP as shown in FIG. 6. This AuthType AVP field allows the PAA 120 to negotiate an authentication type or protocol with the PaC 100 during an authentication type negotiation phase 570 (see FIG. 5). In another embodiment, the field may be implemented with another code other than an AVP code (e.g., by way of one of reserved fields) as long as it can allow the PaC 100 to select an authentication protocol from the list. In a typical PANA based authentication system, the AVP code is EAP (see FIG. 2).

AVPs are generally used to encapsulate information relevant to the PANA message. A more detailed description of the AVP field or code can be found, for example, by Forsberg, D., Ohba, Y., Patil, B., Tschofenig, H. and A. Yegin, at “Protocol for Carrying Authentication for Network Access,” draft-ietf-pana-pana-10, July 2005, which is incorporated herein by reference.

In the embodiment where EAP and CHAP are included, the AuthType AVP field of the PSR message includes bit flags defined for EAP and CHAP as shown in FIG. 6. In this embodiment, the PAA 120 sets (e.g., using either “0” or “1” bit) one or more of the defined bit-flags.

The PaC 100 receives the PSR message from the PAA 120 and checks the list provided in the AuthType AVP field (420). If the PaC 100 selects CHAP in state 430, the PaC 100 sends a PANA start answer (PSA) message, with the CHAP flag bit in the AuthType AVP field set, to the PAA 120 (440 in FIG. 4 and 520 in FIG. 5). In one embodiment, if the PSR message includes other (new) authentication protocol and the PaC 100 selects that protocol, the PaC 100 may send a PSA message, with the new protocol flag bit in the AuthType AVP code set, to the PAA 120. Thereafter, the PAA 120 and PaC 100 proceed authentication with CHAP (460 in FIG. 4 and 530-560 in FIG. 5). If the PaC 100 does not select CHAP in state 430, the PaC 100 sends a PSA message, with the EAP flag bit in the AuthType AVP field set, to the PAA 120 (450). Thereafter, the PAA 120 and PaC 100 proceed authentication with CHAP/EAP (470).

In one embodiment, as shown in FIG. 5, the authentication procedure includes three phases: an authentication type negotiation phase 570, a CHAP authentication phase 580 and an authentication completion phase 590. During the authentication type negotiation phase 570, the PAA 120 sends a PSR message listing authentication types (e.g., EAP and CHAP) to the PaC 100 (510) and the PaC 100 sends a PSA message including a selected authentication protocol (e.g., CHAP) to the PAA 120 (520). During the CHAP authentication phase 580, the PAA 120 sends a PANA-auth-request (PAR) message including a challenge value to the PaC 100 (530). In response, the PaC 100 computes a response value and transmits a PANA-auth-answer (PAN) message including the response value to the PAA 120 (540). During the authentication completion phase 590, the PAA 120 verifies the response. If the challenge and response match, the PAA 120 sends a PANA-bind-request (PBR) message indicating authentication success to the PaC 100 (550). If they do not match, the PAA 120 sends a failure message to the PaC 100. In reply to the PBR message, the PaC 100 acknowledges the receipt of the result by sending a PANA-bind-answer (PBA) message to the PAA 120 (560).

FIG. 8 illustrates an exemplary flowchart which shows a PANA based authentication procedure according to another embodiment of the invention. Referring to FIG. 7, the authentication procedure as shown in FIG. 8 will be described in more detail. The PAA 120 sends a PSR message including a CHAP AVP field as shown in FIG. 7 to the PaC 100 (810). This embodiment allows the PAA 120 to initiate CHAP during the authentication type negotiation phase 570 (see FIG. 5). In this embodiment, the AVP code is defined as CHAP as shown in FIG. 7.

The PaC 100 receives the PSR message from the PAA 120 and checks the CHAP AVP code of the PSR message (820). If the PaC 100 is configured to or selects to use CHAP in state 830, the PaC 100 sends a PSA message including the CHAP AVP field to the PAA 120 (840). Thereafter, the PAA 120 and PaC 100 proceed authentication with CHAP (860). If the PaC 100 does not use CHAP in state 830, the PaC 100 discards the received CHAP AVP code and sends a PSA message to the PAA 120 (850). Thereafter, the PAA 120 and PaC 100 proceed authentication with CHAP/EAP (870).

According to one embodiment, networks such as CDMA 2000 and DSL networks can use CHAP/PANA without requiring EAP or CHAP/L2. Furthermore, in certain network systems where a single authentication method such as CHAP is dominantly used, and resource constraints discourage use of EAP, one embodiment of the invention allows for the use of CHAP/PANA instead of CHAP/EAP/PANA, reducing the network implementation costs.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A method of authenticating a communication entity in a communication system based on a protocol for carrying authentication for network access (PANA), the method comprising:
transmitting, at a PANA authentication agent (PAA), a PANA start request (PSR) message to a PANA client (PaC), wherein the PSR message includes a field which allows the PaC to select one of a plurality of authentication protocols;
receiving, at the PaC, the PSR message;
selecting, at the PaC, one of the plurality of protocols; and
transmitting, at the PaC, a PANA start answer (PSA) message to the PAA, wherein the PSA message includes a field indicative of the selected protocol.

2. The method of claim 1, wherein the field of the PSR message is an authentication type attribute value pair (AVP) field listing the plurality of authentication protocols.

3. The method of claim 1, wherein the plurality of authentication protocols include an extensible authentication protocol (EAP) and a challenge handshake authentication protocol (CHAP).

4. A method of authenticating a communication entity in a communication system based on a protocol for carrying authentication for network access (PANA), the method comprising:
transmitting a PANA start request (PSR) message to a PANA client (PaC), wherein the PSR message includes a code which allows the PaC to select one of a plurality of authentication protocols; and
receiving a PANA start answer (PSA) message from the PaC, wherein the PSA message includes a code indicative of a selected one of the plurality of authentication protocols.

5. The method of claim 4, wherein the code of the PSR message is an authentication type attribute value pair (AVP) code listing the plurality of authentication protocols.

6. The method of claim 4, wherein the plurality of authentication protocols include an extensible authentication protocol (EAP) and a challenge handshake authentication protocol (CHAP).

7. The method of claim 4, further comprising proceeding authentication with the selected protocol.

8. The method of claim 7, wherein the selected protocol is CHAP.

9. A system for authenticating a communication entity in a communication system based on a protocol for carrying authentication for network access (PANA), the system comprising:
a transmitter configured to transmit a PANA start request (PSR) message to a PANA client (PaC), wherein the PSR message includes a code which allows the PaC to select one of a plurality of authentication protocols; and
a receiver configured to receive a PANA start answer (PSA) message from the PaC, wherein the PSA message includes a code indicative of a selected one of the plurality of authentication protocols.

10. The system of claim 9, wherein the authentication system is a PANA authentication agent (PAA).

11. The system of claim 9, wherein the system is for use with a code division multiple access (CDMA) 2000 network or a digital subscriber line (DSL) broadband access network.

12. A system for authenticating a communication entity in a communication system based on a protocol for carrying authentication for network access (PANA), the system comprising:
means for receiving a PANA start request (PSR) message from a PANA authentication agent (PAA), wherein the PSR message includes an authentication type field listing a plurality of authentication protocols;
means for selecting a protocol from the plurality of protocols; and
means for transmitting a PANA start answer (PSA) message to the PAA, wherein the PSA message includes an authentication type field indicative of the selected protocol.

13. The system of claim 12, further comprising means for setting a CHAP bit flag in the authentication type field of the PSA message before transmission.

14. A method of authenticating a communication entity in a communication system based on a protocol for carrying authentication for network access (PANA), the method comprising:
transmitting a PANA start request (PSR) message to a PANA client (PaC), wherein the PSR message includes a field which allows the PaC to select one of an extensible authentication protocol (EAP) and a challenge handshake authentication protocol (CHAP); and
receiving a PANA start answer (PSA) message from the PaC, wherein the PSA message includes a field indicative of a selected one of EAP and CHAP.

15. The method of claim 14, wherein the field of the PSR message is an authentication type attribute value pair (AVP) field listing EAP and CHAP.

16. The method of claim 14, wherein the selected protocol is CHAP.

17. The method of claim 14, wherein the transmitting and receiving are performed at a PANA authentication agent (PAA).

18. A computer data signal for authenticating a communication entity in a communication system based on a protocol for carrying authentication for network access (PANA), the signal comprising:
a PANA start request (PSR) message which is configured to be transmitted to a PANA client (PaC), wherein the PSR message includes a code which allows the PaC to select one of an extensible authentication protocol (EAP) and a challenge handshake authentication protocol (CHAP).

19. The signal of claim 18, further comprising:
a PANA start answer (PSA) message configured to be transmitted to a PANA agent (PAA), wherein the PSA message includes a code indicative of a selected one of the EAP and CHAP.

20. The signal of claim 18, wherein the code is an authentication type attribute value pair (AVP) code listing EAP and CHAP.

21. A method of authenticating a communication entity in a communication system based on a protocol for carrying authentication for network access (PANA), the method comprising:
transmitting, at a PANA authentication agent (PAA), a PANA start request (PSR) message to a PANA client (PaC), wherein the PSR message includes a field which allows for the use of a challenge handshake authentication protocol (CHAP) without an extensible authentication protocol (EAP);
receiving, at the PaC, the PSR message;
transmitting, at the PaC, a PANA start answer (PSA) message to the PAA, wherein the PSA message includes a field which confirms the use of CHAP without EAP; and
proceeding authentication with CHAP without using EAP.

22. A method of authenticating a communication entity in a communication system based on a protocol for carrying authentication for network access (PANA), the method comprising:
transmitting a PANA start request (PSR) message to a PANA client (PaC), wherein the PSR message includes a field which allows for the use of a challenge handshake authentication protocol (CHAP) without an extensible authentication protocol (EAP); and
receiving a PANA start answer (PSA) message from the PaC, wherein the PSA message includes a field which confirms the use of CHAP without EAP.

23. The method of claim 22, further comprising proceeding authentication with CHAP without using EAP.

24. The method of claim 22, wherein the field of the PSR message is an attribute value pair (AVP) field listing CHAP.

25. The method of claim 22, wherein the transmitting and receiving are performed at a PANA authentication agent (PAA).
